(19) United States
(12) Patent Application Publication
(10) Pub. No.: US 2015/0163550 A1
(43) Pub. Date: Jun. 11, 2015

(54) SYSTEM AND METHOD FOR MULTIDIMENSIONAL CONTENT RATING

(71) Applicant: Tinj, Co., San Francisco, CA (US)

(72) Inventor: Mat Tyndall, San Francisco, CA (US)

(73) Assignee: TINJ, CO., San Francisco, CA (US)

(21) Appl. No.: 14/565,195

(22) Filed: Dec. 9, 2014

Related U.S. Application Data
(60) Provisional application No. 61/914,511, filed on Dec. 11, 2013.
(60) Provisional application No. 61/986,393, filed on Apr. 30, 2014.

(51) Int. Cl. H04N 21/475; H04N 21/258; H04N 21/8545; H04N 21/658; H04N 21/431; G06F 3/01; H04N 21/442

(52) U.S. Cl. CPC H04N 21/4756; G06F 3/017; H04N 21/25891; H04N 21/44213; H04N 21/658; H04N 21/4312; H04N 21/8545

(57) ABSTRACT

Methods for multidimensional content rating using an electronic computing device are presented, the methods including: causing the electronic computing device to initiate content; delivering the content to a user; initiating a curve application; and if an attribute is pre-selected, indicating a user's experience during the delivered content with respect to the attribute by the user using the curve application. In some embodiments, methods further include: displaying results of the user's experience; transforming the results of the user's experience into a curve; and analyzing the results of the user's experience. In some embodiments, analyzing the results includes; matching different parts of the curve to an actual timeline of the content thereby identifying which content elements provoked which user experiences and to what relative extent.

### FIELD OF INVENTION

This disclosure relates to evaluating content or experiences on a multidimensional level using, for example, one or more computer processors.

### BACKGROUND

Monitoring the experience of a viewer of an event or participant in an event provides critical information for those creators and distributors of such content. Such monitoring may be real-time or post event, providing valuable information as to tastes, meeting of expectations, preferences, and the like.

Real-time monitoring may take place during the actual occurrence of the event, as for example by way of a focus group. The real-time monitoring, although valuable, often interferes with the live experiencing of the event leading to distracted results. Post event monitoring although also of great value, relies on polls often comprising of a singular cumulative rating falling short of a representative experience.

Thus, the advances in the rating industry, there is room for further improvement in providing non-disruptive evaluation systems and methods for more comprehensive and actionable feedback.

### SUMMARY

The present invention is directed to methods and systems for one or more users to express their experience related to content or events over time. In an embodiment, the user expresses his/her feelings regarding the content after the event (or a segment thereof) has passed in time. In an embodiment, the user expresses her feelings about the event by digitally inputting (e.g., by way of touch screens) data points which are analyzed and converted to a curve. In an embodiment, the user, may draw the curve in real-time as she is rating the content, or as scattered data points along a multidimensional chart (e.g., x and y axis) where the y-axis represents a particular feeling like overall enjoyment or scariness, and the x-axis represents time from start to end (with or without a scale).

In an embodiment, the user expresses how she feels over time by drawing the curve on a 2D canvas on a phone/tablet/computer/motion captured gesture (camera or sensor).

Users prompted with this interface, can quickly draw a curve using their finger or input device to trace their rating for the content over time. This curve may then be analyzed to match the different parts of the curve to the actual timeline of the content or service, thereby identifying which elements provoked which reaction.

Movie sites typically rate a TV series on a 1-5 scale, even though a series may comprise many seasons and many episodes within a season. While a user may view all or almost all of the seasons and/or episodes, not every episode or season evokes the same emotion from the viewer. Similarly content may evoke a range of emotions or experiences from a viewer which a single number may not sufficiently describe.

Furthermore, visual representation, as in a curve, can provide multiple data in a way that is easy understandable and communicable by and between viewers. Viewers can express their feelings about one or more timed events by visually engaging and examining the shape and amplitude of the curve along the time-axis (e.g., x-axis). Alternatively and/or additionally, using varying types of algorithms such curve-represented data may be converted to single data points or algebraic equations whereby those with interest in the data can ascertain, for example, at point along a series certain plots may evoke more desirable or expected emotions from the viewer/s.

In other embodiments, methods for evaluating a content experienced over time are presented including: initiating an event; delivering content associated with the event; selecting an attribute to rate corresponding with the event; rating the content on a display canvas; and displaying a resulting curve on the display canvas. In some embodiments, curves are analyzed to provide insight into a user's experience. In other embodiments, methods for generally creating a curve with references images are presented including: providing reference images for an event to a user; displaying a curve interface for rating the event at reference image points; drawing a curve corresponding with rating the event; mapping the event to a time position, smoothing the curve drawn; and analyzing results of the curve to provide insight into a user's experience. In still other embodiments, methods for generally creating a curve on a mobile device synched to a TV and the cloud are presented including: selecting content for viewing; streaming content from a cloud enabled processing environment; watching the streaming content; displaying key frames to a user, where the key frames correspond with the streaming content; synchronizing a drawn curve to the cloud; analyzing the curve; aggregating curves from a number of other curves; and displaying aggregated curves to the user.

In other embodiments, methods for multidimensional content rating using an electronic computing device are presented, the methods including: causing the electronic computing device to initiate content; delivering the content to a user; initiating a curve application; and if an attribute is pre-selected, indicating a user's experience during the delivered content with respect to the attribute by the user using the curve application. In some embodiments, methods further include: displaying results of the user's experience; transforming the results of the user's experience into a curve; and analyzing the results of the user's experience. In some embodiments, analyzing the results includes; matching different parts of the curve to an actual timeline of the content thereby identifying which content elements provoked which user experiences and to what relative extent. In some embodiments, if the attribute is not pre-selected, selecting by the user an attribute; and indicating a user's experience during the delivered content with respect to the attribute by the user using the curve application. In some embodiments, before causing the electronic computing device to initiate content, configuring a number of options corresponding with the content and the user. In some embodiments, methods the options are selected from the group consisting of: a date of content, a time of content, and an evaluation criteria. In some embodiments, the content is selected from the group consisting of: video content, audio content, and audio/video content. In some embodiments, the attribute represents a user's overall feeling selected from the group consisting of: excitement, joy, sadness, surprise, and fear. In some embodiments, methods causing the electronic computing device to initiate content includes: loading a number of reference images for the content; and synchronizing the number of reference images with a number of curve time points, and where delivering the content to the user includes: displaying each of the number of reference images corresponding with each of the number of curve time point. In some embodiments, methods further include: displaying a recommended content based on the results of the user's experience to the user; displaying other users having a similar user experience to the user; and displaying a number of aggregate curves from other users to the user.

In other embodiments, computing device program products for multidimensional content rating using a computing device are presented, the computing device program product including: a non-transitory computer readable medium; first programmatic instructions for causing the electronic computing device to initiate content; second programmatic instructions for delivering the content to a user; third programmatic instructions for initiating a curve application; and if an attribute is pre-selected, fourth programmatic instructions for indicating a user's experience during the delivered content with respect to the attribute by the user using the curve application, where the programmatic instructions are stored on the non-transitory computer readable medium. In some embodiments, program products further include: fifth programmatic instructions displaying results of the user's experience; sixth programmatic instructions transforming the results of the user's experience into a curve; and seventh programmatic instructions analyzing the results of the user's experience. In some embodiments, seventh programmatic instructions analyzing the results comprises: matching different parts of the curve to an actual timeline of the content thereby identifying which content elements provoked which user experiences and to what relative extent. In some embodiments, program products further include: if the attribute is not pre-selected, eighth programmatic instructions selecting by the user an attribute; and ninth programmatic instructions indicating a user's experience during the delivered content with respect to the attribute by the user using the curve application. In some embodiments, program product further include: before causing the electronic computing device to initiate content, tenth programmatic instructions configuring a number of options corresponding with the content and the user (115). In some embodiments, the attribute represents a user's overall feeling selected from the group consisting of: excitement, joy, sadness, surprise, and fear. In some embodiments, first programmatic instructions for causing the electronic computing device to initiate content includes: eleventh programmatic instructions for loading a number of reference images for the content; and twelfth programmatic instructions for synchronizing the number of reference images with a number of curve time points, and where second programmatic instructions for delivering the content to the user includes: thirteenth programmatic instructions for displaying each of the number of reference images corresponding with each of the number of curve time point. In some embodiments, program products further include: fourteenth programmatic instructions for displaying a recommended content based on the results of the user's experience to the user; fifteenth programmatic instructions for displaying other users having a similar user experience to the user; and sixteenth programmatic instructions for displaying a number of aggregate curves from other users to the user.

In other embodiments, systems of computer hardware for multidimensional content rating using an electronic computing device are presented, the systems including: a processor for, causing the electronic computer hardware to initiate content; delivering the content to a user; initiating a curve application; if an attribute is pre-selected, indicating a user's experience during the delivered content with respect to the attribute by the user using the curve application; displaying results of the user's experience; transforming the results of the user's experience into a curve; and analyzing the results of the user's experience.

In embodiments, selecting a part of the timeline or playing a part of a video may move the curve time indicator to the selected moment and display corresponding annotations. In addition, displaying a curve as a rating such as specific, aggregate or personalized may facilitate decision making such as whether to watch one video or another. In some embodiments, curves may have interaction modes such as draw, display only, or annotation, where each mode would allow for specific ways a user could interact with curves. In still other embodiments, use of draw speed, number of edits, and other metadata from drawing a curve may be utilized in matching and/or analyzing curves.

In some embodiments, in order to make drawing a curve easier, a predicted curve rating can be displayed so the user only needs to modify the predicted curve. Alternatively, multiple suggested curve ratings could be displayed so the user can select the curve most appropriate to his personal view or feeling. Additional information may, in some embodiments, also be triggered to display at selected portions as the user draws their curve rating. For example, branching in the paths of other curve ratings, detailed time markers, images, etc. may be triggered during drawing a curve. In other embodiments, displaying a curve or aggregate curves with the corresponding content listing may assist users in viewing or interacting with the content. Curves may be displayed in similar manner to star ratings.

It should be understood that the aforementioned implementations are merely example implementations, and that claimed subject matter is not necessarily limited to any particular aspect of these example implementations.

### BRIEF DESCRIPTION OF DRAWINGS

Claimed subject matter is particularly pointed out and distinctly claimed in the concluding portion of the specification (when present). However, both as to organization and/or method of operation, together with objects, features, and/or advantages thereof, may best be understood by reference to the following detailed description if read with the accompanying drawings in which:

FIG. 1 is a schematic representation of a curve canvas embodying features of the present invention.

FIG. 2 is a schematic representation of a completed curve embodying features of the present invention.

FIG. 3 is a schematic representation of a curve with an extended canvas embodying features of the present invention.

FIG. 4 is a schematic representation of a curve scrubber with separate video player and canvas embodying features of the present invention.

FIG. 5 is a schematic representation of a curve scrubber canvas overlaid on a video player embodying features of the present invention.

FIG. 6 is a schematic representation of a curve with a scrubber with a TV and phone embodying features of the present invention.

FIG. 7 is a schematic representation of a curve with key frame overlay embodying features of the present invention.

FIG. 8 is a schematic representation of a composite curve embodying features of the present invention.

FIG. 9 is a schematic representation of a combination curve embodying features of the present invention.

FIG. 10 is a schematic representation of directional drawing a curve embodying features of the present invention.

FIG. 11 is a schematic representation of a curve with dynamic images embodying features of the present invention.

FIG. 12 is a schematic representation of a curve magnifying glass feature. embodying features of the present invention.

FIG. 13 is a diagram of an embodiment that includes an apparatus for curve generation using multiple user interfaces embodying features of the present invention.

FIG. 14 is a flow diagram illustrating an embodiment of a method for generally evaluating a content, event, or experience embodying features of the present invention.

FIG. 15 is a flow diagram illustrating an embodiment of a method for generally creating a curve with references images embodying features of the present invention.

FIG. 16 is a flow diagram illustrating an embodiment of a method for generally creating a curve on a mobile device synched to a TV and the cloud embodying features of the present invention.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example”, “one feature”, “one embodiment”, “an example”, “a feature”, or “an embodiment” means that a particular feature, structure, or characteristic described in connection with a feature, example or embodiment is included in at least one feature, example or embodiment of claimed subject matter. Thus, appearances of the phrase “in one example”, “an example”, “in one feature” “a feature”, “an embodiment”, or “in one embodiment” in various places throughout this specification are not necessarily all referring to the same feature, example, or embodiment. Furthermore, particular features, structures, or characteristics may be combined in one or more examples, features, or embodiments.

According to one or more implementations, as discussed herein, a system or method may be provided for: aiding, by way of one or more computer processors, for example; a rating or evaluation process of a content, experience, event or the like.

Although embodiments may be described in the context of movies or shows, the same may be useful and practiced in other forms of events which occur over time, including but not limited to: a road trip, a multi-episode series, a multi-season series, a concert, eating experience, a course, or class. Embodiments may be applied to a variety of alternative situations, and claimed subject matter is not limited in this respect.

As previously mentioned, there is a need for easily, intuitively, and meaningfully capture, evaluate, and communicate a viewer's (e.g., experiencer, rater, participant) or multiple viewers' feelings, thoughts, or perceptions regarding an event (e.g., content, experience, movie, road trip, concert) that has, in part or in total, taken place in the past (past may be defined broadly as a few seconds to days, weeks, months, and so forth before the rating takes place).

In an embodiment, a multi-dimensional (e.g., two-dimensional) rating system, as herein referred to as a curve, may be used to provide a more comprehensive rating of an event or content that a viewer has experienced or participated in. In operation, a viewer (or rater) may create a curve (e.g., having multiple coordinates such as an x and y coordinates) by drawing such a curve on a multi-dimensional (e.g. two-dimensional) canvas on a device such as a tablet, smart phone, personal computer, or in front of sensor or camera. For purposes of discussion, a two-dimensional canvas with two coordinates (x and y) may be used to further illustrate exemplary embodiments.

The curves may also provide valuable feedback on pacing, enjoyment, etc., for entertainment, courses, books, articles, and the like. In an embodiment, a curve may be used any time after a user has experienced an event including events where a user's perception changes over the course of the experience and/or over time. Curves are visual and humans have a better ability for processing information visually than they do other forms such as numbers and/or text.

A curve may be challenging to communicate in writing or audibly. Drawing a curve on paper is possible but requires extra steps to analyze. Drawing on a computer using a mouse or trackpad is possible but difficult to control quickly. Touch interfaces on mobile devices and tablets give users excellent control for quickly drawing curves.

In an embodiment, the device is a touch-screen device, although other devices capable of creating similar output are within the scope of the present invention.

For the purposes of discussion, and without intending any limitations, the following terms as used herein will generally have the following meanings: Curve: 2D rating over time; Canvas: 2D drawing surface for a curve; Viewport: contains the canvas; Extended canvas: canvas that extends beyond the viewport; Content: something a user can interact with over a time period or an experience a user has been a part of; Content time point: moment in time during the content; Content time period: period or time range during the content; Nearby content time points: content time points in close proximity to another content time point; Interaction point: point of the curve the user is interacting with representing a content time point; Content reference: image or text correlated with time point.

In a two-dimensional canvas, the two coordinates may be represented as a y-axis representing a particular feeling of the rater, such as overall enjoyment, scariness, boredom, excitement, and the like; while the x-axis represents time from start to end (with or without a scale) of an event, in part or in its entirety.

Users prompted with this interface, can relatively and quickly draw a curve using their finger or other input devices to trace their rating of the content over time. This curve may further be analyzed to match the different parts of the curve to the actual timeline of the content, service, or experience, thereby identifying which elements provoked which reactions and to what relative extent.

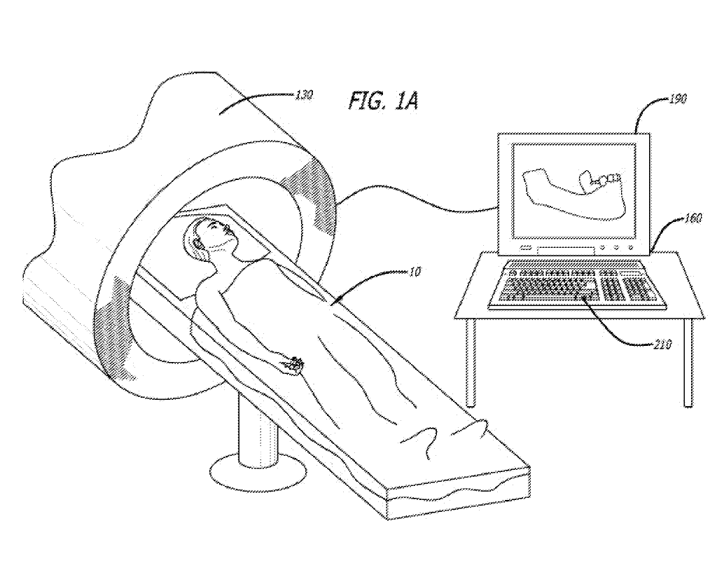

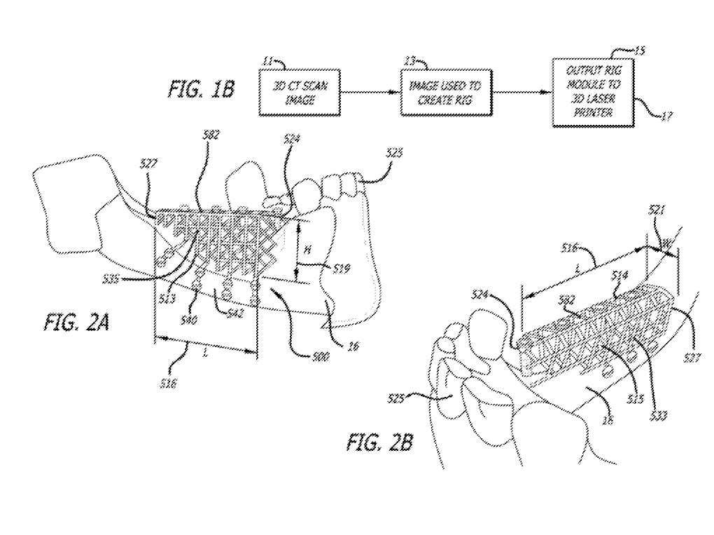

Now referring to FIGS. 1-3 a drawing area (canvas) having a two-dimensional drawing surface for drawing or generating a curve is shown. The canvas may be rectangular (as shown) or of other suitable shape/s with different coordinate systems such as polar coordinate system.

FIG. 1 is a schematic representation of a curve canvas embodying features of the present invention. A canvas 112 may include an x-axis corresponding to a time scale 102 with a start and an end of an event or content; and a y-axis or rating scale 104 for rating a particular content time point for a given attribute, for example “current point 108” as identified on the curve 110 in FIG. 1. The time scale 102 or timeline may include annotations, symbols or images for key events. The y-axis may be numerical as shown, or reflective of a more subjective rating system (e.g., agree, no-opinion, disagree) or no identifiable scale at all. The canvas 112 may further include a reference line 106 which may be indicative of how someone (such as the user) may feel about a reference event or content time period of the event being rated or some other event. The axes, in some embodiments may be interchanged. The position of a neutral reference line 106 can be adjusted to change the ratio of positive space compared to negative space and would impact the shape of any curves drawn. An internal coordinate system may be used to translate from the x-y inputs to the curve coordinates for analysis and storage and back to x-y for display.

The data that a curve may capture is more informative than single number rating (e.g., 1-5) systems while still requiring very little time or effort from users. In an embodiment a curve is generated by sampling input positions within a drawing window over a canvas, then plotting those points on the canvas and connecting them together to form a continuous line. Points may be connected lines that are straight, curved (Bezier), or any other shape. The data, whether as single points or a curve may be editable by the user.

In an embodiment, the curve may be generated as the user draws the curve with an input instrument (e.g., user's finger, stylus) or it may be generated from a series of points tapped (e.g., touched on a touch screen) onto the canvas by the user, and thereafter connected either by the user or by a program. Recording the time or relative time may be done for each data point for analysis and playback. Faster draw times may mean a lower expected accuracy; slower draw times may mean the user took time for accuracy. Draw speed can be used to alter the thickness, color, or other properties of a curve. In an alternative embodiment, a curve may be used as a method of input for things other than ratings such as volume for a song or playback speed for a video.

In an embodiment, curves may be horizontally continuous on the x-axis (as for example representing time) but may have different amplitudes along the y-axis. There could be multiple y-axis (e.g., different axis on different canvases, or for example one y-axis on one side and another on the other side of the canvas) for a given content (e.g., each y-axis for expression of a particular feeling such as anger, happiness) either on the same canvas or separately generated canvases and thereafter overlaid. Alternatively, different curves may be generated using the same y-axis but with different values, each curve indicative of a different feeling. Different curve patterns may be named (e.g., an “S” curve) and identified which can aid in communication of the results between various users or different content.

The most common scale for the x-axis may be time, continuous or discrete, but other scales are possible including distance for a car trip, episodes in a TV series, pages in a book, or a musical show, concert, or play. The scale on the y-axis may be an overall sentiment but may also represent any sub or meta attribute that changes over time. Rating scales can be displayed in various formats such as numbers and hash marks or color-coded. The rating scale 104 may or may not be displayed. Scales may be linear. In some embodiments, scales are not linear or do not have set boundaries on either side. The scales may also be normalized for a given “rater”. In an alternative embodiment, a graph with curves feature may enable modification of a traditional line chart with a curve such as by drawing an overlaying curve, extending the chart with curves or converting the line chart to a curve.

As shown in FIG. 2, which is a schematic representation of a completed curve embodying features of the present invention, in an embodiment, the user may make annotations 202 of peaks, valleys, inflection points or any area a user seeks to comment upon. These points can be correlated with video, images, text or data from that point in time and optionally displayed to the user. Annotations 202 may be used as explanation by asking users to explain the shape of a part of their curve (i.e. peak, drop), users can more easily explain themselves because they've already provided context. Annotation matching may show users annotations linked to matching curve segments. If a user has a downward curve at a certain point tied to a comment/annotation, it is probably most relevant to another user that had a similar curve segment at that time point. In the same way, contrasting opinions can be found from curve segments of different shapes Annotation hiding may be completely or partially done for instance to prevent spoilers. In an embodiment, select points 204 of interest or focal points may be used to rate so that only a few decision points and curves converge more easily.

An area feature enables a user drawing upper and lower bounds for a section of a curve to create an area. One method is using two fingers to draw two lines with one finger representing the upper bound and the other the lower bound. Alternatively toggling a modifier would enable a second line to be drawn without overwriting the first. An area reflects a range of possible values for the curve in that section. In still another embodiment, the user may draw a continuous squiggly line where the peaks of the squiggles trace the upper and lower boundaries of the curve.

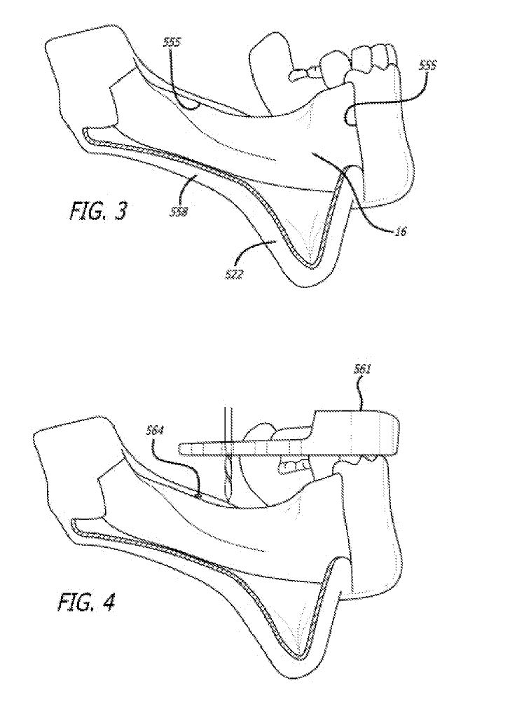

Time scale 102 may be adjusted either by zooming in or by displaying a portion of the space at any one time. The drawing window may shift (automatically or by the user) as the user creates the curve (i.e., same as the canvas shifting left) or vice versa. In an embodiment, variable time scales may provide the ability to change between different time scales such as different sets of key points, no context, sections, or different time step size. The section of content being evaluated can change or remain the same. Key points between users may be varied to alter context and collect more precise data for different parts of a curve. A curve may be systematically “filled in” by showing a different subset of key points to different users. Key points can be personalized to a user such as a sequence to craft a specific narrative (romantic progression) or types of points (action scenes) that a user is more interested and engaged in. Users could select/swipe between different timeline references with different user interface (UI) indicators. Selecting between different timeline references could correspond to different draw modes like freeform to key points. Extended canvases 302, as shown in FIG. 3, which is a schematic representation of a curve with an extended canvas embodying features of the present invention, may also be implemented and recessed behind the screen of the input device. Extended canvases include curve view port 304, that displays a curve canvas 306 that represents a portion of extended curve canvas 308. As may be seen, a user control point 310 controls shape of a curve.

An underlying or background image (not show) may appear on the canvas behind the curve depending on a part or the whole curve as a reference or to add context for the user or viewer (or rater). The underlying image may be an image of the content from the current or a nearby time point. Alternatively the image can be something that reflects the user's feeling overall or at the point, such as a warm and fuzzy image when the curve is very positive. When drawing a curve for rating the day or the experience, the background could display the image or animation of the day/night cycle corresponding to time, weather and location synched to the curve position. Representations for the content such as a waveform for audio can be used as a reference.

In drawing the curve, different brush styles (not shown) may be used, which are either set before, after, or dynamically based on a series of factors. An exemplary scenario includes when the user wishes to express the severity or intensity of her feeling about an attribute related to a time point while creating the curve, as another way to emphasize her feeling in addition to the amplitude of the curve at the time point. Styles, size, and colors of brushes, can similarly be used to further describe or emphasize (or deemphasize) a particular feedback for a particular time event. Colors, line thickness, brush style, shape, dimensionality, transparency and other properties may be combined together to produce the desired visual effect. In an embodiment, a real-time curve may be provided when drawing a curve for a live event, a line indicating the present can separate the past and the future. The ‘present’ line would move over the course of the event. Users could draw curves normally and anything on the “future” side would be a prediction and would communicate how the user expects things to turn out. Users could update their curves before, during and after the event has occurred. In another embodiment, curves may be smoothed out from the raw data to various degrees either under user control or automatically. Smoothing can be done to make curves more visually appealing, to reduce noise, or convey a lower level of detail. In yet another embodiment, a blur feature may blur segments to either indicate lower confidence or to hide or obfuscate a curve from users. Changing the opacity may work the same as blur. Changing the width may convey a range of possibilities.

When a curve is drawn after watching a video where the playback can be controlled, curves may be integrated with the playback controls to display key frames from the video in sync with the user's current time position in the curve. A curve index enables curves to be used to help users find or navigate to specific sections based on the shape of an overall curve. A user could use the overall shape or even draw a specific curve segment that could be matched to a segment previously drawn by that user or other users. Selecting a point on a curve can navigate to find a specific section of content such as a passage in a book, scene in a movie, or episode in a series. Curve indexing makes it easy to skip over boring parts or skip directly to good parts as indicated by the shape of the curve.

Similarly, selecting a part of the timeline or playing a part of a video may move the curve time indicator to the selected moment and display corresponding annotations. In addition, displaying a curve as a rating such as specific, aggregate or personalized may facilitate decision making such as whether to watch one video or another. In some embodiments, curves may have interaction modes such as draw, display only, or annotation, where each mode would allow for specific ways a user could interact with curves. In still other embodiments, use of draw speed, number of edits, and other metadata or sensor data (pressure, accelerometer, etc) from drawing a curve may be utilized in displaying, matching and/or analyzing curves.

In some embodiments, in order to make drawing a curve easier, a predicted curve rating can be displayed so the user only needs to modify the predicted curve. Alternatively, multiple suggested curve ratings could be displayed so the user can select the curve most appropriate to his personal view or feeling. Additional information may, in some embodiments, also be triggered to display at selected portions as the user draws their curve rating. For example, branching in the paths of other curve ratings, detailed time markers, images, etc. may be triggered during drawing a curve. In other embodiments, displaying a curve or aggregate curves with the corresponding content listing may assist users in viewing or interacting with the content. Curves may be displayed in similar manner to star ratings.

Using a hook curve feature addresses the problem that people often don't finish content because they stop before they get hooked. A hook curve would convey to users the point at which they should expect to be hooked. A hook curve could be personalized. A hook curve only shows the curve from the start up to the point when a user should expect to be hooked. (Hook curve: first ten minutes of episode 1, whole curve: curve for entire series.) A hook curve enables showing a user just enough of a curve to convey when things get good.

A second pass feature enables a user to draw a curve, analyze the curve, then provide more details/context for key points so the user can edit for additional precision (for instance adjusting the height of a peak based on a more detailed description). A second pass can also be done after accurately syncing the timeline between the curve and content.

Facial animation sequencing enables curve data to animate a face or avatar (like a smiley face) through the emotional sequence in the curve since a curve can correspond to various emotional reactions. Facial animation sequencing could be a more accessible way of communicating the meaning behind a curve to users. Different faces, animations and emotions could be unlocked via payment or other means.

In an embodiment, various types of multimedia may be attached to a part of a curve such as sounds, images, video or text. In another embodiment, music matching may match a curve to music based on algorithmic or music curve data. Music matching provides an accompaniment for a curve and can enrich the experience. Music can also be automatically generated to match the mood in a curve. An audio feature may convert a curve to sound effects with the same ups/downs of the curve. Similarly, audio input may be converted to the shape of a curve. Varying the pitch or volume over time may be used as a non-visual interface.

In yet another embodiment, curve emotional analysis may deduce a users emotional state or reaction from the shape of a curve or curves. Curve emotional analysis may be represented back to the user to convey understanding. Emotional state can be directly collected or inferred from curve data (slope, shape, input speed, etc.). Inputting curves on a regular basis can catalog the emotional context in a person's life. Emotional context or states could be shared, embedded, integrated, or attached to other content. In still another embodiment, mood based recommendations may be made for content based on the curve for a user's day. For instance recommending something with an “uplifting” curve if the user's curve indicates a lousy or stressful day.

A privacy and sharing feature may be configured based on an event period. For example, the parts of a curve when a user is at work could be shared with an employer with consent. The amount and precision of shared data could be configured, such as hiding annotations by default. A lock feature may enable curves in general to have a lock/unlock button to toggle the ability to edit a curve.

A thumbnail feature may weight the importance of thumbnails for a video by the shape of a curve. Thumbnails at points of interest would be weighted more heavily and be preferentially shown to other users. Thumbnails that are for parts users do not engage in can be down weighted and eventually removed. Other properties corresponding to that image or time point can be scored as well. Can also be applied to other forms of media synced to the curve timeline.

A comprehension feature enables users to draw a curve to demonstrate comprehension of the contents of an event. The user's curve can be scored against an official curve. This can also be used to measure if a user understands the relative importance of each part of an event through a curve. A learning curve can be used to convey perceived progress towards learning a concept or reaching a goal. The metric can be level of understanding, milestones, mastery, or whichever makes the most sense.

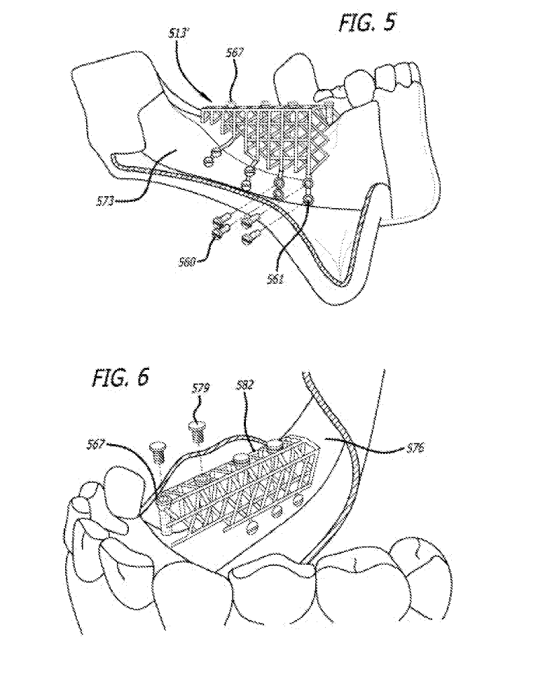

Now referring to FIG. 4, which is a schematic representation of a curve scrubber with separate video player and canvas 402 embodying features of the present invention, similar to video scrubbing (or seeking) where one can drag the time position or synced position 404 for a video player 406 and see key frames or video element 408 from those scenes, curves 410 may be used as a 2D scrubber/rating area 412 where the x-axis is the same as normal (with key frames) and the y-axis corresponds to the user sentiment at that time. Showing images synched to time points 404 may aid the user sync her rating with the timeline and acts as a reminder of what the particular content was at that time. In an embodiment, the playback may be set at a rate faster than the original content (or key frames were played at) since the viewer has already seen the content and the key frames are there primarily to serve as reminders. The speed of the playback may be automatically set by the program or set and/or controllable by the user. The settings may be “edited” to provide a more accurate relationship. The playback images (key frames) provide context so the rater can more precisely express her opinion about specific content time points. Curves may be combined with any video scrubbing method. An image stacking feature enables groups of images being “stacked” together and played as an animated sequence, for instance if there are more images or frames than can easily be displayed side by side. By way of example, curves may be combined, as shown in FIG. 5, which is a schematic representation of a curve scrubber canvas 502 overlaid on a video player embodying features of the present invention as a relatively smaller image overlaid on the image player (e.g., video player).

The curve drawing area can be above, below or overlaid on top of the video player. In addition, the video (or content) player 602 may be on another device such as a TV 606 while the curve drawing area 612 may be on a phone or tablet 610, as shown in FIG. 6, which is a schematic representation of a curve with a scrubber 604 with a TV 606 and phone 610 embodying features of the present invention.

Auto-play for the video may be disabled to prevent distraction and gaps in the rating timeline. Key frames, screenshots, or other images correlated to time points can be strung together as an alternative to video. Synched audio may be combined with visual cues.

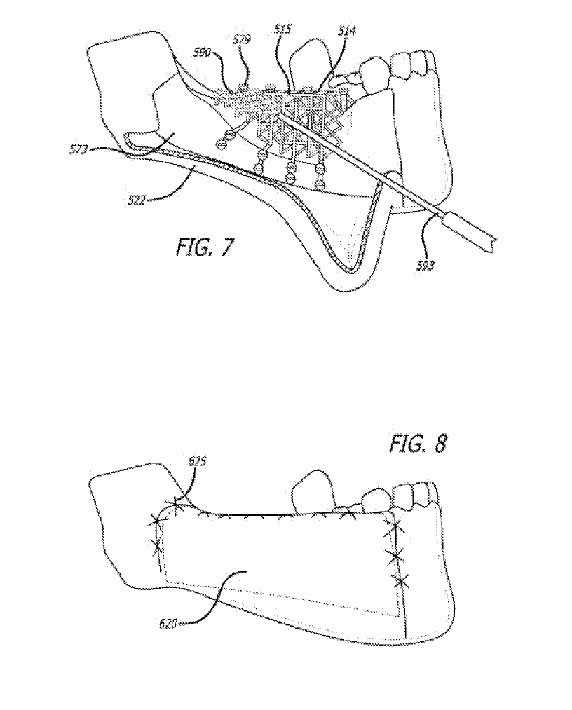

By way of example and as shown in FIG. 7, which FIG. 7 is a schematic representation of a curve with key frame overlay embodying features of the present invention, curve 704 may have segmented or discrete key frames 702 overlaid thereon. If no video playback is available or just as an alternative, images may be captured from the video stream (or from the event, such as a road-trip) with timestamps and stored locally (e.g., temporarily) to provide a similar experience when drawing a curve. Time stamped image streams can also come from any external source (e.g., camera). Images that capture the essence of that time point are ideal and can be preferentially included algorithmically and/or through curating. In an embodiment, the key frames are from scenes which have been saved.

Referring briefly back to FIG. 2, various parts of a curve such as peaks, valleys, or inflection points may correspond to points of interest and may further be annotated as described earlier. Curves may be stored locally or synched to a cloud service over a network. Analysis may be done locally on the input device or in the cloud.

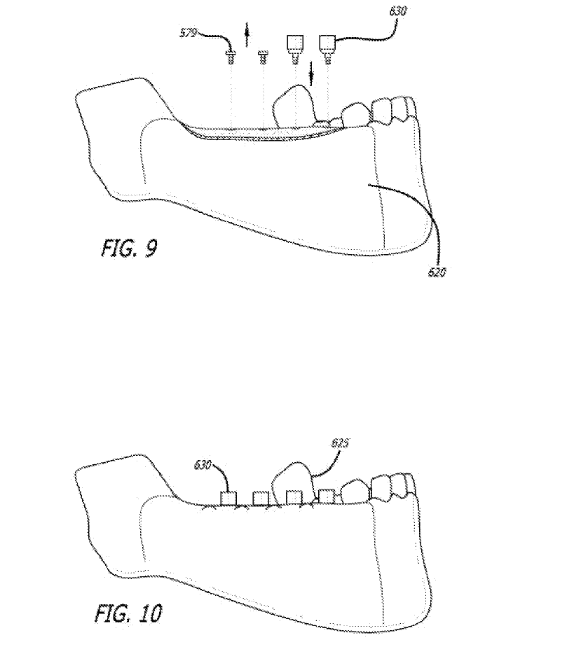

Now referring to FIG. 8, which is a schematic representation of a composite curve embodying features of the present invention. As illustrated, multiple curves 802, 804, and 806 from the same timeline may be stitched together over time and optionally combined with a master curve 808 that covers a larger time frame, such as when combining curves for episodes, seasons or the whole series together. A segments feature enables curve segments to be represented as separate curves that may be merged together if their ends overlap. An overall rating line feature may enable a user to rate an experience overall (e.g. 4/5 stars) and this rating can be used to generate a reference line for a follow up curve rating allowing the user to easily express which parts were better or worse than the overall rating. A grid feature may enable users to draw multiple curves arranged in a grid pattern (i.e. a three by three grid or four by four grid). In an embodiment the grid could be presented three dimensionally (3D) to the user or manipulated by the user in 3D space.

Now referring to FIG. 9, which is a schematic representation of a combination curve 908 embodying features of the present invention, curves 902, 904, and 906 may be grouped together for the same event by differences in experiences. For example, at a conference where attendees listened to different speakers in different rooms for part of the event, the curves for those parts may be different. Similar parts of curves between users indicate they had similar experiences during that time. Differences in the curve of individual raters may be based on the differences in their taste, location, or content, surrounding, etc. The aggregation and combination of the curves may still provide an overall indication of the event and the general feelings about various attributes of the event or the content. Branching curves can be created when users have partially overlapping experiences.

As shown in FIG. 9. one or more raters may express their feelings about the same content simultaneously, collaboratively, or independently of one another. Such multiple feedbacks may be analyzed to provide a more comprehensive picture of the content. Curves from multiple users may be combined to visualize their combined perception and to show trends. Curves from many users may be combined together to show trends and patterns. Users with similar curve profiles likely have similar tastes since they reacted in sync which can be the basis for recommendations. Regressions (linear, quadratic, etc.) can be used to model and analyze curves, in addition to more advanced techniques.

It is possible for users to adjust the scale of their curve after it was drawn without changing the basic shape. This may be done by adding a vertical offset. Changing the slope of the curve may be done by fixing the start and end points to the edges so the user can move them up or down separately which would proportionally shift the rest of the curve. Regions could also be expanded or contracted.

It can still be useful to convert a curve to a singular numerical rating, for familiarity or for comparing to conventional data sources. A simple way to do this would be taking an average over time, but more sophisticated algorithms are likely to be more in sync with user perception. The effective rating can be calibrated by allowing the user to input an overall rating which can tune the effective rating algorithm, adjust the shape of the curve or both.

Curves may be used to capture expectations either before, during or after an event is taking place. These projections can be contrasted against regular post-event curves to gain insight in expectations and reality differed and when.

It may also be desirable to see the user's expectations before experiencing an event versus how they felt afterwards. In an embodiment, a user may also draw a prediction of their curve either as a completely separate curve or joined to their curve up to that point using a separator between past and future.

Accuracy adjustments may be made by adjusting the accuracy/shape of a curve using data from other curves by the same and/or other users. For example, a user could draw a quick curve with a peak in the middle, with that peak position adjusted to line up with the peaks of other users. This can be done for the current curve or when displaying/analyzing previously collected curves.

In an embodiment, curve compatibility may be done by two or more users comparing/contrasting their curves to see if they are compatible or just to gain more insight into each other's perception. A user can also attempt to draw a curve representing the other user's perspective, which can be compared/contrasted with the curve the other user drew for themselves. Curve compatibility can be used to measure the level of understanding or emotional intelligence one user has for another.

In addition, in embodiments, curves may be shared publicly using social media. Curves may be reformatted or stylized for visual appeal and packaged as images.

Now referring to FIG. 10, which is a schematic representation of directional drawing a curve embodying features of the present invention, a directional drawing feature enables users to draw when moving right 1002 but erasing when moving left 1004. Erasing segments is possible by touching/clicking in the middle of a curve and then moving left. Editing is possible by touching/clicking and then moving to the right to overwrite the previous curve. Users would naturally draw with the arrow of time so using movements in the opposite direction to erase points is an easy gesture for editing.

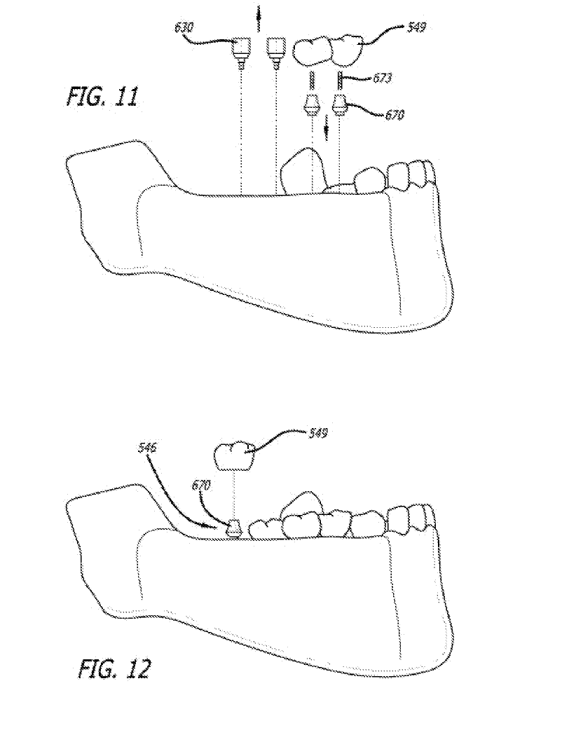

Now referring to FIG. 11, which is a schematic representation of a curve with dynamic images embodying features of the present invention, curves with dynamic images 1102 enables drawing a curve with images as references, the images move while rating to their part of the curve in such a way that they hover above the curve. Dynamic images allow the images to not be visually blocked from the user by their finger or other input implement in addition to positioning the images at heights that correspond with the height of the curve at their time point. This can be combined with parallax scrolling of images. The opacity, size, color or other properties of images can also be adjusted by the curve height or current position such as enlarging the current image or shrinking previous images.

Now referring to FIG. 12, which is a schematic representation of a curve magnifying glass feature. embodying features of the present invention, a magnifying glass feature 1202 solves the problem when touch interfaces may make precise input of curves challenging because a user's finger covers up the curve. Therefore, a “magnifying glass” can appear above the current point showing an enlarged view of the curve hidden behind the user's finger. This view can also contain a mini scale.

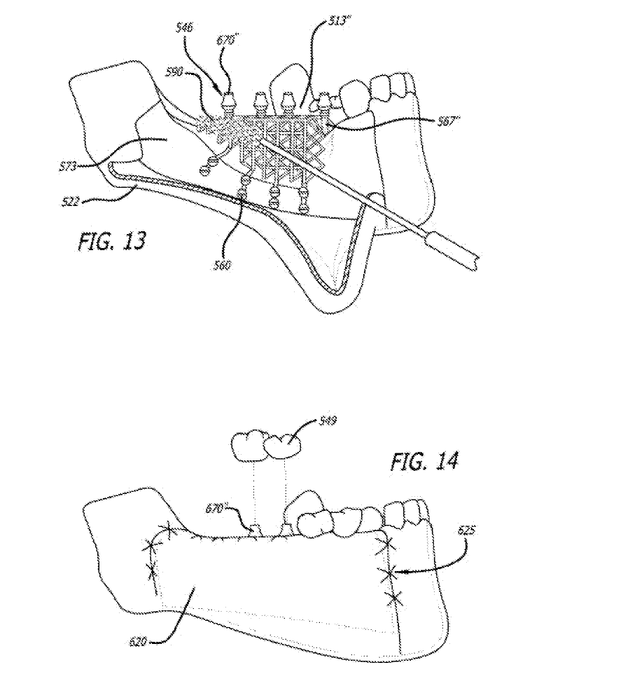

FIG. 13 is a diagram of an embodiment that includes a system 100 for curve generation using multiple user interfaces. In FIG. 13, a computing platform 30 may comprise, for example, a processor 60 (which may comprise one or more processors or processing units) and a memory 70 coupled by a communications bus 80. A processor and a memory coupled by a bus comprises an example embodiment of a computing device, although computing platform 30 includes more components in this embodiment, as illustrated in FIG. 13. For example, computing platform 30, which comprises a computing device, further includes a communications interface 40, and an input/output module 50. Likewise, memory 70, as illustrated, may comprise primary memory 74 and secondary memory 76, for example.

In FIG. 13, a group of users (one or more) may interact with user interfaces 25a, 25b, and 25c, which may communicate with computing platform 30 by way of a network connection through network 20, such as the Internet. Although FIG. 13 shows only three user interfaces (25a, 25b, 25c), any number of user interfaces may be utilized without limitation. Further, the users may interact with the platform independently, simultaneously, or cumulatively. Although the computing platform of FIG. 13 shows the above-identified components, claimed subject matter is not limited to computing platforms comprising only these components as other implementations may include alternative arrangements that may include additional components, fewer components, or components that may operate differently while achieving similar results.

Processor or processing unit 60 may be representative of one or more circuits, such as digital circuits, to perform at least a portion of a computing procedure or process. By way of example but not limitation, processing unit 60 may comprise one or more processors (or sub-processors, for example), controllers, microprocessors, microcontrollers, application specific integrated circuits, digital signal processors, programmable logic devices, field programmable gate arrays, the like, or any combination thereof.

Memory 70 may be representative of any signal storage mechanism. Memory 70 may include, for example, primary memory 74 and/or secondary memory 76, although nothing prevents a use of additional memory circuits, mechanisms, or combinations thereof. Memory 70 may comprise, for example, random access memory, read only memory, or one or more data storage devices or systems, such as, for example, a disk drive, an optical disc drive, a tape drive, a solid-state memory drive, to name just a few examples. Memory 70 may be utilized to store state or signal information relating to outcomes of previous elections, for example. Memory 70 may also comprise a memory controller for accessing computer readable-medium 75, also illustrated in FIG. 13, that may carry and/or make accessible content, code, and/or instructions, for example, such as may be executable by processing unit 60 or some other controller or processor capable of executing instructions.

Network 20 may comprise one or more communication links, processes, and/or resources to support exchanging communication signals between a device (not shown), such as a client (not shown) which may be operated by a user, such as 25a, for example, and computing platform 30. For example, in an embodiment, computing platform 30 may comprise one or more servers. By way of example but not limitation, network 20 may include wireless and/or wired communication links, telephone or telecommunications systems, Wi-Fi networks, Wi-MAX networks, the Internet, the web, a local area network (LAN), a wide area network (WAN), or any combination thereof.

The term “computing platform” as used herein refers to a system and/or a device that includes an ability to process and/or store data in the form of signals and/or states, such as a computing device. Thus, a computing platform, in this context, may comprise hardware, software, firmware, or any combination thereof. Computing platform 30, as depicted in FIG. 13, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, digital video recorder (DVR), cable box, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 70 may store cookies relating to one or more users, such as one or more users interacting with the user interface 25a, 25b, and/or 25c, for example, and may also comprise a computer-readable medium that may carry and/or make accessible content, code and/or instructions, for example, executable by processing unit 60 or some other controller or processor capable of executing instructions, for example. One or more of users interacting with user interface 25a, 25b, and/or 25c, may make use of an input device, which may comprise a computer mouse, stylus, track ball, keyboard (e.g., virtual or non-virtual), or any other device capable of receiving as an input a physical motion or the like, such as a mouse click, a key being pressed or a similar example, to generate a signal, for example, to be communicated, such as to another device, across, a network, etc.

A computer-readable (storage) medium, such as computer-readable medium 75 of FIG. 13, typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite a change in state.

User interfaces 25a, 25b, and/or 25c may make use of client resources, such as a computing platform that may comprise a computing device, as one example. Likewise, a client computing platform that may comprise a computing device may include a browser utilized to, e.g., view or otherwise access content, such as, from the Internet. A browser may comprise a standalone application, or an application embedded in or forming at least part of another program or operating system, etc. Client resources, such as a computing platform that may comprise a computing device, as one example, may also include or present a graphical user interface. An interface, such as GUI, may include, for example, an electronic display screen, or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples. In an example embodiment, a user interacting with one or more of user interface 25a, 25b, and/or 25c, may submit a content selection to be placed on a sub list, although claimed subject matter is not limited in scope in this respect. Signals may be transmitted via client resources to a server system, such as computing platform 30, for example, via a communications network, such as network 20, for example. A variety of approaches are possible and claimed subject matter is intended to cover such approaches.

In embodiments, computing platform 30 may implement the methods of FIGS. 14-16 described herein, which may comprise, for example, a method for expressing a user's experience with respect to an event which occurs over time.

FIG. 14, is a flow diagram generally illustrating an embodiment of a method for a evaluating a content experienced over time embodying features of the present invention. The method of FIG. 14 may be performed, for example, by computing platform 30 of FIG. 13, or may be performed by alternative structures and systems. Further, although particular blocks comprising the method of FIG. 14 are described, claimed subject matter is not limited to embodiments performing the actions described with reference to FIG. 14. Rather, embodiments may comprise steps in addition to those shown and described in FIG. 14, as well as embodiments comprising fewer and/or steps than those described in FIG. 14.

The method of FIG. 14 may begin at block 110 in which an event is initiated. As utilized herein the terms “event” and “content” are substantially similar terms and may utilized interchangeably without limitation. An event may be any event which occurs over a period of time such as a movie, TV series, or as described above. Options, such as date, time, evaluation criteria, and the like, may be pre-configured at block 115. Over a period of time, the user experiences the event (120). Such period of time may be a few minutes, the entire period delivering content (e.g., video content, audio content, snapshots of an event such as photographs or audio clips). At block 125, the method determines whether the user is ready to rate. If the user is not ready to rate, the method continues to a block 130 to generate a reminder for future rating whereupon the method returns to a block 125.

If at block 125, the user is ready to provide his/her rating, she will move forward to block 135 where the curve program embodiment is initiated. It should be kept in mind, that the program may be initiated earlier than block 135, as for example at the start of block 110 or at any point in between. The curve program embodiment may run in the background or concurrently on the same device as that which is delivering the content or other devices.

At block 140, the method determines whether the attribute which is to be rated is pre-selected. If the attribute is not pre-selected, the user moves to block 145 where she selects the attribute and moves onto block 155. Alternatively, if the method determines that the attribute is pre-selected at a block 140, the user is prompted to rate the content as it relates to that attribute at a block 150. Examples of such attributes may be the overall feeling that the user may have experienced, or particular feelings, such as excitement, joy, sadness, surprise, fear, etc.

At block 155, the user touches (e.g., by way of finger, stylus, and the like) the canvas along a y-axis corresponding to the selected attribute and which feeling corresponds to various content time points (along the x-axis); which data is displayed visually on a device running the Canvas (block 160). Alternatively, the user may, instead of identifying points, draw a line wherein the y-axis corresponds to the user's degree of feeling as a function of time on the x-axis. At block 165 the data points may be transformed into a curve. The method continues to a block 170 where the results may be analyzed whereupon the method ends. As noted above, curves may be analyzed to match the different parts of the curve to the actual timeline of the content, service, or experience, thereby identifying which elements provoked which reactions and to what relative extent. Analysis may be accomplished locally on the input device or in the cloud.

It may further be desirable to communicate the curve in a more mathematical form, for example, a single number or an algebraic equation for comparison with other curves created by other users. Such mathematical calculations may be performed using regression analysis, evaluating area under the curve, etc without departing from embodiments herein.

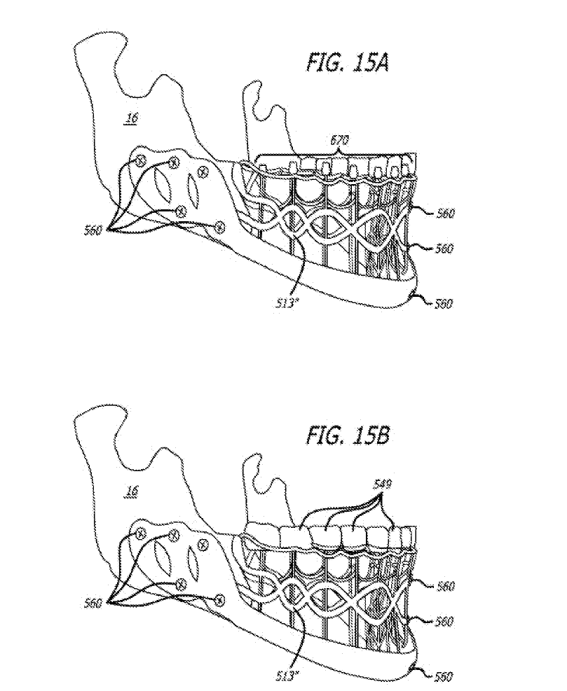

FIG. 15 is another flow diagram illustrating an embodiment of a method for evaluating a content experienced over time utilizing reference images embodying features of the present invention. As noted above, showing reference images synched to time points may aid the user sync her rating with the timeline and acts as a reminder of what the particular content was at that time. At a first block 205, the user may open a curve generating application. At a next block 210, the event to be rated may be selected. As utilized herein the terms “event” and “content” are substantially similar terms and may utilized interchangeably without limitation. Events may be any event which occurs over a period of time such as a movie, TV series, or as described above. At a next block 220, the method initiates the curve program embodiment. As above, the program may be initiated earlier than block 220, as for example at the start of block 205 or at any point in between. The curve program embodiment may run in the background or concurrently on the same device as that which is delivering the content or other devices. Upon initiation of the curve program embodiment at a step 220, the method loads references images for the event at a block 230. Reference images may be loaded in any manner known in the art without departing from the present invention and may be loaded in any number of various formats and resolutions depending on the user device and user preferences. At a next block 225, the method displays the curve interface that receives user input. As noted above, the curve interface may be displayed on any of a variety of interface devices such as a tablet, a laptop, a phone, or a standalone display without limitation.

At a next block 235, the user touches or clicks on the canvas whereupon at a next block 240, the user draws a curve on the canvas. The method branches at a block 240 to both process received input as well as receive user input. At one branch for receiving user input, at a block 275, the user stops whereupon the method determines at a block 295 whether the user is done. If the method determines that the user is not done at a block 295, the method returns to a block 235. If the method determines at a block 295 that the user is done, the method continues to a block 310 to complete the curve. Returning to branch point 240, the method continues to a block 245 to receive current position over curve canvas based on the user input. The method then maps the received current position to an event time point at a block 250. In one embodiment, the method continues to a block 255 to display a reference image corresponding with the received event time point. The method continues to a block 260 to determine whether the received data point is new. If the method determines at a block 260 that the data point is new, the method continues to a step 270 to add an array of points indexed by x. If the method determines at a block 260 that the data point is not new, the method continues to a block 265 to update the data point. In some embodiments, the method proceeds to a block 285 to algorithmically smooth the curve. Smoothing may be accomplished in any manner known in the art without departing from present embodiments. The method then continues to a block 280 to update the curve drawing on canvas with new points received. In other embodiments, the method continues to a block 290 to synchronize curve data to the cloud. Synchronization to the cloud may provide flexibility in data sharing as well as data analysis. The method continues to a block 305 to analyze results. As noted above, curves may be analyzed to match the different parts of the curve to the actual timeline of the content, service, or experience, thereby identifying which elements provoked which reactions and to what relative extent. Analysis may be accomplished locally on the input device or in the cloud.

In some embodiments, methods may continue to block 315 to show results; to block 320 to show similar users; or to block 325 to display aggregate curves. As noted above, curves may be grouped together for the same event by differences in experiences. For example, at a conference where attendees listened to different speakers in different rooms for part of the event, the curves for those parts may be different. Similar parts of curves between users indicate they had similar experiences during that time. Differences in the curve of individual raters may be based on the differences in their taste, location, or content, surrounding, etc. The aggregation and combination of the curves may still provide an overall indication of the event and the general feelings about various attributes of the event or the content. In addition, methods may share curves and results via social media at a block 330. Curves may be shared publicly using social media. Curves may be reformatted or stylized for visual appeal and packaged as images.

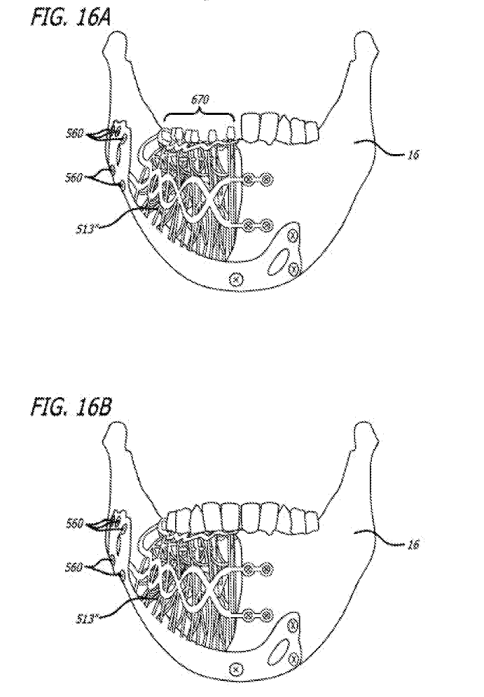

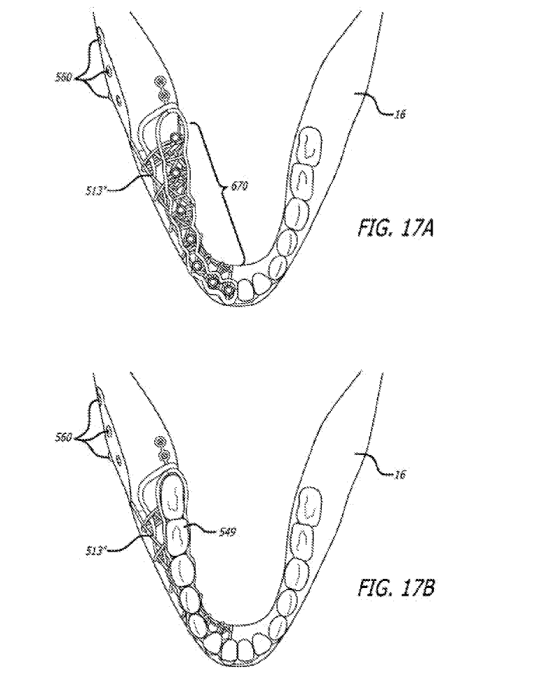

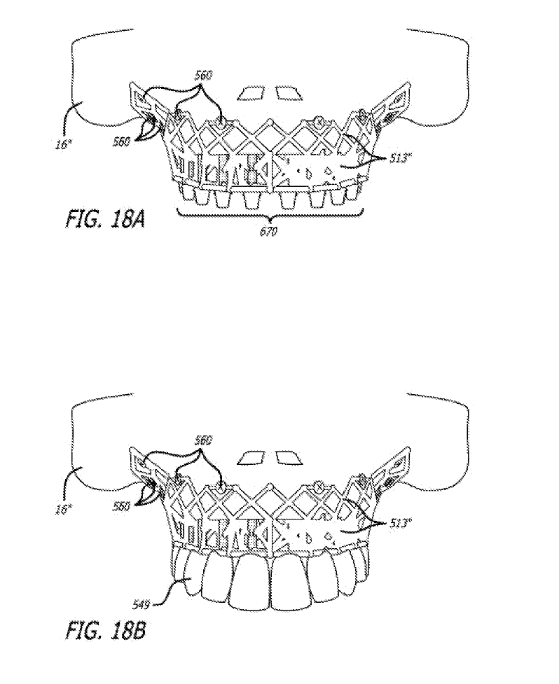

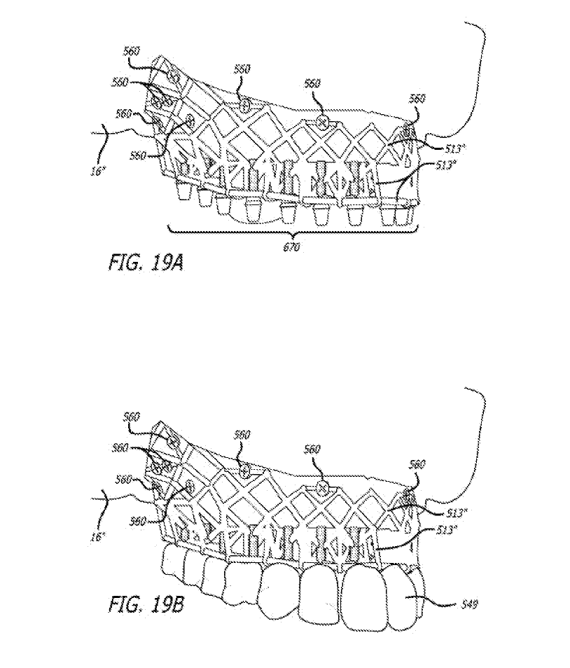

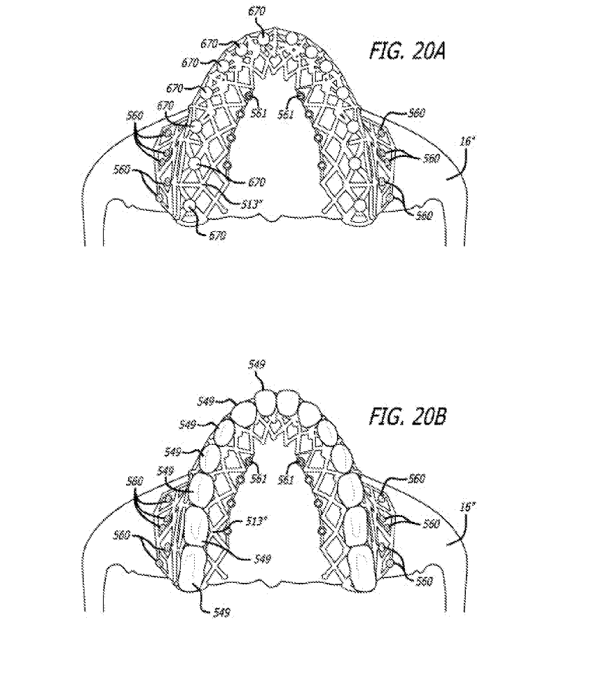

FIG. 16 is another flow diagram illustrating an embodiment of a method for generally creating a curve on a mobile device synched to a TV and the cloud embodying features of the present invention. The method provided will be discussed in relation to three separate systems, that is, a mobile device, the cloud, and a TV or display. As such, at a first block 405, the user opens a curve generating application. At a next step 410, the user selects a program or show to watch. The method continues to a step 505 to begin streaming from the cloud to a TV or display. At a block 605, the content begins, is viewed by the user at a block 610, and ends at a block 615. The method continues to initialize the curve program embodiment at a block 510. It may be appreciated that the curve program embodiment may be initiated earlier than block 510, as for example at the start of block 405 or at any point in between. The curve program embodiment may run in the background or concurrently on the same device as that which is delivering the content or other devices. At a block 510, the method branches.

At a cloud branch the method continues to a block 515 to synchronize video and curve time points to the start, whereupon the method continues to a block 620 to display video key frame or reference image for current curve time point. At a user branch, the method continues to a block 415 where the curve program embodiment prompts for video. The method may then alternatively display curve canvas block 425 or display curve instructions at a block 420. The method continues to a block 430 where a user draws a curve for the video. As may be appreciated, drawing a curve may be accomplished using a finger or stylus on a touch screen enabled display or may be entered via a mouse or keyboard without limitation. While the user draws a curve to a displayed video at a block 430, the method synchronizes the curve to the cloud at a block 520. Synchronization may occur simultaneously or over some pre-defined interval as desired.

Once a user has finished drawing a curve at block 435, the method may analyze results at a block 525. Analysis may occur simultaneously with user input, or may occur after all user input has been received without limitation. In some embodiments, at a block 530, the method combines analyzed results with other curves. As noted above, curves may be grouped together for the same event by differences in experiences. For example, where several different users watched video content at different times in different locations the curves for those parts may be different. Similar parts of curves between users indicate they had similar experiences during that time. Differences in the curve of individual raters may be based on the differences in their taste, location, or content, surrounding, etc . . The aggregation and combination of the curves may still provide an overall indication of the content and the general feelings about various attributes of the content. The method continues to display aggregate curves on a TV or display at a block 625 or a mobile device at a block 440 or both.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing”, “computing,”, “calculating”, “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to the particular examples disclosed, but that such claimed subject matter may also include all aspects falling within appended claims and/or equivalents thereof.

What is claimed is:

1. A method for multidimensional content rating using an electronic computing device, the method comprising:
causing the electronic computing device to initiate content;
delivering the content to a user;
initiating a curve application; and
if an attribute is pre-selected, indicating a user's experience during the delivered content with respect to the attribute by the user using the curve application.

2. The method of claim 1, further comprising:
displaying results of the user's experience;
transforming the results of the user's experience into a curve; and
analyzing the results of the user's experience.

3. The method of claim 2, wherein analyzing the results comprises;
matching different parts of the curve to an actual timeline of the content thereby identifying which content elements provoked which user experiences and to what relative extent.

4. The method of claim 1, further comprising:
if the attribute is not pre-selected, selecting by the user an attribute; and
indicating a user's experience during the delivered content with respect to the attribute by the user using the curve application.

5. The method of claim 1, further comprising:
before causing the electronic computing device to initiate content, configuring a plurality of options corresponding with the content and the user.

6. The method of claim 5, wherein the plurality of options are selected from the group consisting of: a date of content, a time of content, and an evaluation criteria.

7. The method of claim 1, wherein the content is selected from the group consisting of:
video content, audio content, and audio/video content.

8. The method of claim 1, wherein the attribute represent a user's overall feeling selected from the group consisting of: excitement, joy, sadness, surprise, and fear.

9. The method of claim 2, wherein
causing the electronic computing device to initiate content comprises:
loading a plurality of reference images for the content; and
synchronizing the plurality of reference images with a plurality of curve time points, and wherein
delivering the content to the user comprises:
displaying each of the plurality of reference images corresponding with each of the plurality of curve time point.

10. The method of claim 9, further comprising:
displaying a recommended content based on the results of the user's experience to the user;
displaying other users having a similar user experience to the user; and
displaying a plurality of aggregate curves from other users to the user.

11. A computing device program product for multidimensional content rating using a computing device, the computing device program product comprising:
a non-transitory computer readable medium;
first programmatic instructions for causing the electronic computing device to initiate content;
second programmatic instructions for delivering the content to a user;
third programmatic instructions for initiating a curve application; and
if an attribute is pre-selected, fourth programmatic instructions for indicating a user's experience during the delivered content with respect to the attribute by the user using the curve application, wherein the programmatic instructions are stored on the non-transitory computer readable medium.

12. The program product of claim 11, further comprising:
fifth programmatic instructions displaying results of the user's experience;
sixth programmatic instructions transforming the results of the user's experience into a curve; and
seventh programmatic instructions analyzing the results of the user's experience.

13. The program product of claim 12, wherein seventh programmatic instructions analyzing the results comprises:
matching different parts of the curve to an actual timeline of the content thereby identifying which content elements provoked which user experiences and to what relative extent.

14. The program product of claim 11, further comprising:
if the attribute is not pre-selected, eighth programmatic instructions selecting by the user an attribute; and
ninth programmatic instructions indicating a user's experience during the delivered content with respect to the attribute by the user using the curve application.

15. The program product of claim 11, further comprising:
before causing the electronic computing device to initiate content, tenth programmatic instructions configuring a plurality of options corresponding with the content and the user.

17. The program product of claim 11, wherein the attribute represent a user's overall feeling selected from the group consisting of: excitement, joy, sadness, surprise, and fear.

18. The program product of claim 12, wherein
first programmatic instructions for causing the electronic computing device to initiate content comprises:
eleventh programmatic instructions for loading a plurality of reference images for the content; and
twelfth programmatic instructions for synchronizing the plurality of reference images with a plurality of curve time points, and wherein
second programmatic instructions for delivering the content to the user comprises:
thirteenth programmatic instructions for displaying each of the plurality of reference images corresponding with each of the plurality of curve time point.

19. The program product of claim B7, further comprising:
fourteenth programmatic instructions for displaying a recommended content based on the results of the user's experience to the user;
fifteenth programmatic instructions for displaying other users having a similar user experience to the user; and
sixteenth programmatic instructions for displaying a plurality of aggregate curves from other users to the user.

20. A system of computer hardware for multidimensional content rating using an electronic computing device, the system comprising:
a processor for,
causing the electronic computer hardware to initiate content;
delivering the content to a user;
initiating a curve application;
if an attribute is pre-selected, indicating a user's experience during the delivered content with respect to the attribute by the user using the curve application;
displaying results of the user's experience;
transforming the results of the user's experience into a curve; and
analyzing the results of the user's experience.
